(19) United States
(12) Patent Application Publication
(10) Pub. No.: US 2008/0170599 A1
(43) Pub. Date: Jul. 17, 2008

(54) Calibration Method for Infrared Temperature Measuring Instruments

(75) Inventors: Wei-Ju Lien, Keelung City (TW); Ting-Feng Wu, Taoyuan County (TW); Wei-Xi Lu, Tainan City (TW)

Correspondence Address: WPAT, PC;INTELLECTUAL PROPERTY ATTORNEYS, 2030 MAIN STREET, SUITE 1300, IRVINE, CA, 92614, US

(73) Assignee: SHANG MEI PRECISION INDUSTRIAL CO., LTD., Tao Yuan Hsien (TW)

(21) Appl. No.: 11/623,301

(22) Filed: Jan. 15, 2007

(51) Int. Cl. G01K 15/00

(52) U.S. Cl. 374/2; 374/E15.002

(57) ABSTRACT

A calibration method for infrared temperature measuring instruments is disclosed. The calibration method of the present invention comprises the following five steps: (1) Calibrating the heat-flux resistor of an infrared temperature measuring instrument so as to obtain its calibrated resistance value (2) Using a digital multimeter to measure the parameters of the components and relevant circuits of the infrared temperature measuring instrument (3) Placing the infrared temperature measuring instrument in a blackbody radiation furnace so as to measure a single-point parameter of the blackbody radiation amplifier because the blackbody radiation furnace can provide a standard blackbody radiation source (4) Using the linear equation to obtain two additional parameters at two other temperatures so as to obtain a linear curve of the blackbody radiation amplifier (5) Storing the calibrated parameters in the memory of the infrared temperature measuring instrument.

### BACKGROUND OF THE INVENTION

1. Field of the Invention

The invention generally relates to a calibration method for infrared temperature measuring instruments. More particularly, the invention relates to a single-point calibration method that enables an infrared temperature measuring instrument to have an error within ±0.2 degree C. (Celsius) when being used to measure temperatures in the range from 32 to 42 degree C. in the ambient temperature range from 22 to 28 degree C.

2. Description of the Prior Art

There are two types of infrared temperature measuring instruments that are used for the measurement of ear temperatures: heat-flux type and blackbody radiation (generally referred to as “infrared”) type. To reduce the range of error, either type needs to be calibrated. In the prior art, the calibration method for infrared temperature measuring instruments comprises the following four steps:

Step 1: Calibrating the heat-flux resistor in a tank filled with 25 degree C. water so as to obtain the calibrated value of the heat-flux resistor.

Step 2: Calibrating the blackbody radiation amplifier in a 32 degree C. blackbody radiation furnace so as to obtain the calibrated value of it at 32 degree C.

Step 3: Calibrating the blackbody radiation amplifier in a 37 degree C. blackbody radiation furnace so as to obtain the calibrated value of it at 37 degree C.

Step 4: Calibrating the blackbody radiation amplifier in a 42 degree C. blackbody radiation furnace so as to obtain the calibrated value of it at 42 degree C.

In the prior art, the three-point calibration method are used to obtain the calibration curve because the imperfect characteristics of the amplifier, analog-to-digital converter, power supply and other relevant circuits of an infrared temperature measuring instrument can not be obtained. Therefore, the calibration method of the prior art can only be used for the temperature range of the ear due to the limited range of accuracy. In addition, such three-point calibration method has the following three disadvantages:

1. The adoption of such three-point calibration method complicates manufacturing process and reduces the efficiency in manufacturing.

2. The adoption of such three-point calibration method requires more measuring devices and facilities, thus increasing manufacturing cost.

3. The three-point calibration method of the prior art can only be used for the temperature range of the ear.

From the above, we can see that the calibration method of the prior art has many disadvantages and needs to be improved.

To eliminate the disadvantages of the calibration method of the prior art, the inventor has put in a lot of effort in the subject matter and has successfully came up with the calibration method for infrared temperature measuring instruments of the present invention.

### SUMMARY OF THE INVENTION

An object of the present invention is to provide a calibration method that can simplify manufacturing process and increase the efficiency in manufacturing.

Another object of the present invention is to provide a calibration method that can lessen the use of measuring devices and facilities and lower the cost in manufacturing.

A third object of the present invention is to provide a calibration method that can be used for the temperature range from 0 to 100 degree C., not just the temperature range of the ear.

A fourth object of the present invention is to provide a calibration method that improves the calibration method of the prior art by providing a simpler single-point calibration method thus simplifying the manufacturing process.

The calibration method for infrared temperature measuring instruments of the present invention comprises the following steps:

Step 1: The heat-flux resistor of an infrared temperature measuring instrument is calibrated so as to obtain its calibrated resistance value so that its range of error is within ±0.3 degree C. in the temperature range from 5 to 42 degree C.

Step 2: Use a digital multimeter to measure the parameters of the amplifier, analog-to-digital converter, power supply and other relevant circuits of the infrared temperature measuring instrument.

Step 3: Place the infrared temperature measuring instrument in a blackbody radiation furnace so as to obtain a single-point parameter of the blackbody radiation amplifier, because the blackbody radiation furnace can provide a standard blackbody radiation source.

Step 4: Use software to obtain two additional parameters at two other temperatures so as to obtain a linear curve for the blackbody radiation amplifier.

Step 5: The calibrated parameters are stored in the memory of the infrared temperature measuring instrument.

These features and advantages of the present invention will be fully understood and appreciated from the following detailed description of the accompanying Drawings.

### BRIEF DESCRIPTION OF THE DRAWINGS

FIG. 1 is a flow chart schematically illustrating the calibration method for infrared temperature measuring instruments of the present invention.

### DETAILED DESCRIPTION OF THE PREFERRED EMBODIMENT

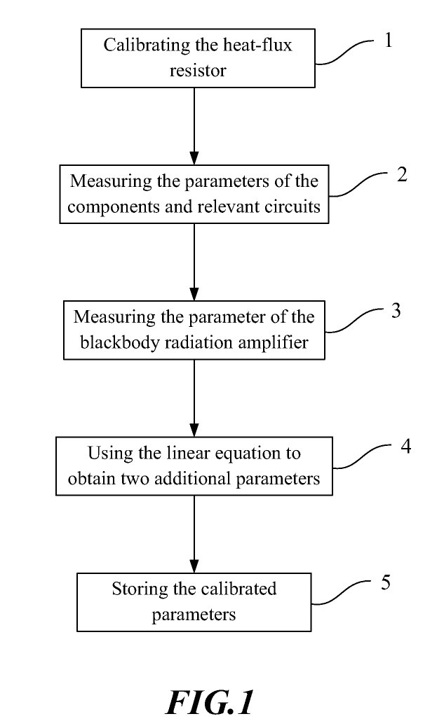

Please see FIG. 1. The calibration method for infrared temperature measuring instruments of the present invention comprises the following steps:

Step 1: The heat-flux resistor of an infrared temperature measuring instrument is calibrated so as to obtain its calibrated resistance value, and so that its range of error is within ±0.3 degree C. in the ambient temperature range from 5 to 42 degree C.

Step 2: Use a digital multimeter to measure the parameters of the amplifier, analog-to-digital converter, power supply and other relevant circuits of the infrared temperature measuring instrument.

Step 3: The blackbody radiation amplifier outputs a signal around 1 mV when an object being measured is at 42 degree C. and the ambient temperature is at 25 degree C. A stabilizing voltage (about 10 mV) is applied at the input end of the amplifier. This voltage may amplify the input signals and the gain (G) of the amplifier may be obtained by using a measuring device. However, because such gain (G) is not the standard gain (Gs), a ratio (Gm) of Gs and G is obtained. Then, the parameter of the heat-flux resistor is used to obtain the ratio (Gbb) of the blackbody value and the standard gain (Gs). Now, the following equation may be used to obtain the single-point calibrated value of the blackbody radiation amplifier: the blackbody voltage of the thermopile=the measured value of the blackbody amplifier×Gm+Gbb.

Step 4: Use the linear equation to obtain two additional parameters at other two temperatures. Now, a linear curve for the blackbody radiation amplifier is obtained.

Step 5: The calibrated parameters are stored in the memory of the infrared temperature measuring instrument. Now, the blackbody amplifier and the heat-flux resistor are calibrated so that the range of error of the infrared temperature measuring instrument of the present invention may be within ±0.2 degree C. when gauging temperature in the range from 32 to 42 degree C. in the ambient temperature range from 22 to 28 degree C.

In comparison to the prior art, the calibration method of the present invention has the following four advantages:

1. In the infrared temperature measuring instrument of the present invention, the single-point calibration method is used so that the manufacturing process may be simplified.

2. In the infrared temperature measuring instrument of the present invention, less calibrating devices are needed so that the cost of manufacturing may be reduced.

3. The infrared temperature measuring instrument of the present invention may be used to measure temperatures ranging from 0 to 100 degree C. (not limited to the temperature range of the ear).

4. The infrared temperature measuring instrument of the present invention may be used to improve the calibration method of the prior art by providing a simpler single-point calibration method thus simplifying the manufacturing process, and broaden the application of infrared temperature measuring instruments.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A calibration method for infrared temperature measuring instruments, comprising the following five steps:
step 1: calibrating the heat-flux resistor of an infrared temperature measuring instrument so as to obtain its calibrated resistance value;
step 2: using a digital multimeter to measure the parameters of the components and relevant circuits of the infrared temperature measuring instrument;
step 3: placing the infrared temperature measuring instrument in a black body furnace so as to measure a single-point parameter of the blackbody radiation amplifier because the blackbody radiation furnace can provide a standard blackbody radiation source;
step 4: using a linear equation to obtain two additional parameters at two other temperatures so as to obtain a linear curve of the blackbody radiation amplifier; and
step 5: storing the calibrated parameters in the memory of the infrared temperature measuring instrument.

2. The method as in claim 1, wherein, in step 1, the range of error of the heat-flux resistor is within ±0.3 degree C. in the ambient temperature range from 5 to 42 degree C.

3. The method as in claim 1, wherein, in step 3, a stabilizing voltage (about 10 mV) is applied at the input end of the blackbody radiation amplifier so as to amplify the input signals and the gain (G) of the amplifier may be obtained by using a measuring device, and wherein a ratio (Gm) of Gs and G is obtained (because such gain (G) is not the standard gain (Gs)) and the parameter of the heat-flux resistor is used to obtain the ratio (Gbb) of the blackbody value and the standard gain (Gs) so that the following equation may be used to obtain the single-point calibrated value of the blackbody radiation amplifier: the blackbody voltage of the thermopile=the measured value of the blackbody radiation amplifier×Gm+Gbb.
